(19) United States
(12) Patent Application Publication
(10) Pub. No.: US 2020/0348502 A1
(43) Pub. Date: Nov. 5, 2020

(54) Methods and Apparatus for Sparse Decomposition Light Field Microscopy

(71) Applicant: Massachusetts Institute of Technology, Cambridge, MA (US)

(72) Inventors: Young-Gyu Yoon, Daejeon (KR); Zeguan Wang, Cambridge, MA (US); Nikita Pak, Redwood City, CA (US); Edward Boyden, Chestnut Hill, MA (US)

(21) Appl. No.: 16/694,270

(22) Filed: Nov. 25, 2019

Related U.S. Application Data
(60) Provisional application No. 62/842,493, filed on May 2, 2019.

(51) Int. Cl. G02B 21/36; G01N 21/64; G02B 21/06

(52) U.S. Cl. CPC G02B 21/365; G02B 21/06; G01N 21/64

(57) ABSTRACT

A light field microscope may record a raw light field video of a sample. The raw video recording may be decomposed into a non-negative low-rank component and a non-negative sparse component. The low-rank component may correspond to a static portion of the sample, and the sparse component may correspond to a dynamically changing portion of the sample. Volume reconstruction may be performed on the sparse component to generate a three-dimensional video of the sample, with improved spatial resolution. In some cases, the decomposition is calculated by an alternating direction method of multipliers algorithm, with the non-negativity of the sparse component and low-rank component enforced after each iteration. In some cases, the volume reconstruction is calculated by Richardson-Lucy iteration with regularization. The sample may be fluorescent. The fluorescence may be indicative of neural activity in the sample.

### RELATED APPLICATIONS

This application claims the benefit of U.S. Provisional Application No. 62/842,493 filed May 2, 2019 (the “Provisional”).

### STATEMENT REGARDING FEDERALLY SPONSORED RESEARCH OR DEVELOPMENT

This invention was made with government support under: (a) Grant Nos. 1R41MH112318 and 1R01MH110932 and 1RM1HG008525 awarded by the National Institute of Health (NIH); (b) NIH Director's Pioneer Award 1DP1NS087724; and (c) contract/grant number W911NF1510548 awarded by the U. S. Army Research Laboratory and the U. S. Army Research Office. The U.S. government has certain rights in this invention.

### FIELD OF TECHNOLOGY

The present invention relates generally to light field microscopy.

### COMPUTER PROGRAM LISTING

The following eleven computer program files are incorporated by reference herein: (1) backwardXLFM.txt with a size of about 1 KB; (2) backwardXLFM1.txt with a size of about 1 KB; (3) backwardXLFMm.txt with a size of about 1 KB; (4) combineMIPs.txt with a size of about 1 KB; (5) deconvRLonestep.txt with a size of about 1 KB; (6) deconvSRLonestep.txt with a size of about 1 KB; (7) forwardXLFM.txt with a size of about 1 KB; (8) forwardXLFM1.txt with a size of about 1 KB; (9) forwardXLFMm.txt with a size of about 1 KB; (10) imshowMIPorth.txt with a size of about 2 KB; and (11) SLdecompose.txt with a size of about 2 KB. Each of these eleven files were created as an ASCII .txt file on Jul. 18, 2019.

### SUMMARY

In illustrative implementations of this invention, a light field microscope records a raw light field video of a sample. The raw video recording may be decomposed into a non-negative low-rank component and a non-negative sparse component. The low-rank component may correspond to a static portion of the sample, and the sparse component may correspond to a dynamically changing portion of the sample. Volume reconstruction may be performed on the sparse component to generate a 3D video of the sample.

We sometimes call this process “sparse decomposition light-field microscopy” or “SDLFM”. In SDLFM, raw light-field video data may be captured by a light-field microscope and may be decomposed into a non-negative low-rank component and a non-negative sparse component, and then volume reconstruction may be performed on the sparse component.

In SDLFM, the video which is reconstructed from the sparse component may have improved spatial resolution, as compared to conventional light field microscopy.

For instance, in some implementations of this invention, the light-field microscope captures a raw light field video of living neural tissue in which neural activity is indicated by fluorescence. The fluorescence that is indicative of neural activity may occur in spikes that are temporally and spatially sparse. When decomposition of the video recording is performed, the sparse component may correspond to dynamically changing neural activity, and the low-rank component may correspond to the static, unchanging portion of the sample which has a steady brightness. Volume reconstruction may be performed on the sparse component, producing a 3D video of the sample with improved spatial resolution. For instance, the spatial resolution may be so improved that neural activity is optically measured with single-cell resolution.

In a prototype of this invention, SDLFM achieved single-cell spatial resolution during in vivo imaging of whole brains of larval zebrafish with lateral and axial full width at half maximum (FWHM) sizes of nuclei of 2.3 micrometers and 5.3 micrometers, respectively, at volumetric imaging rates of up to 50 Hz.

In some implementations, the decomposition is calculated by an alternating direction method of multipliers (ADMM) algorithm, with the non-negativity of the sparse component and low-rank component enforced after each iteration. In some cases, the decomposition into a non-negative low-rank matrix and non-negative sparse matrix is performed by Robust Principal Component Analysis (RCPA), modified in such a way that non-negativity is enforced after each iteration.

In some cases, the volume reconstruction is calculated by Richardson-Lucy iteration, with or without regularization. In some cases, the volume reconstruction is calculated by Landweber iteration, with or without regularization.

In some cases, the light field microscope: (a) includes a microlens array; and (b) has a wide field of view. In some implementations, the light field microscope's wide field of view and the SDLFM enable neuronal activity at the single cell level to be recovered over a large volume. In some cases, the microlens array is located at a plane (which we sometimes call a “conjugated rear focal plane”) at which an image of the rear focal plane of the microscope is formed by light that has been relayed by one or more relay lenses.

In illustrative implementation, the sample as a whole is not moving relative to the light field microscope during the light field video recording (although a portion of the sample may be optically changing, such as by fluorescing).

In illustrative implementations, the decomposition outputs: (a) a sparse matrix that is sparser than the raw light field recording; and (b) a low-rank matrix that has a lower rank than the raw light field recording. The L0 norm of the sparse matrix may be less than the L0 norm of the raw light field recording.

In some implementations, the decomposition into sparse and low-rank matrices is performed without enforcing non-negativity. For instance, this may be desirable in cases where fluorescence dims in response to biological activity.

The Summary and Abstract sections and the title of this document: (a) do not limit this invention; (b) are intended only to give a general introduction to some illustrative implementations of this invention; (c) do not describe all of the details of this invention; and (d) merely describe non-limiting examples of this invention. This invention may be implemented in many other ways. Likewise, the Field of Technology section is not limiting; instead it identifies, in a general, non-exclusive manner, a field of technology to which some implementations of this invention generally relate.

### BRIEF DESCRIPTION OF THE DRAWINGS

FIG. 1 shows a light field microscopy system.

FIG. 2 is a flowchart of a method for sparse decomposition light field microscopy.

FIG. 3 shows a hybrid microscope system.

FIG. 4 is another flowchart of a method for sparse decomposition light field microscopy.

The above Figures are not necessarily drawn to scale. The above Figures show illustrative implementations of this invention, or provide information that relates to those implementations. The examples shown in the above Figures do not limit this invention. This invention may be implemented in many other ways.

### DETAILED DESCRIPTION

### Hardware

In illustrative implementations of this invention, a light-field microscope captures a light-field video recording of a 3D volume of a sample.

In some implementations of this invention: (a) the light-field microscope includes a microlens array; and (b) the microlens array is located at a conjugated rear focal plane of the microscope. The microscope may have a wide field of view. Thus, we sometimes call the microscope an “eXtended field of view light-field microscope” or “XLFM”.

In illustrative implementations, the XLFM includes an sCMOS (scientific complementary metal-oxide-semiconductor) camera that captures the light-field video recording.

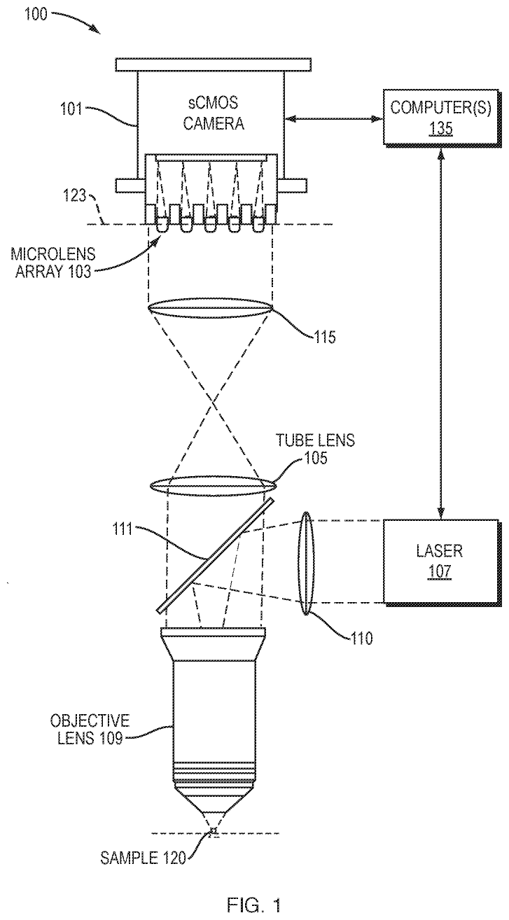

FIG. 1 shows a light field microscopy system, in an illustrative implementation of this invention. Specifically, FIG. 1 shows an XFLM system. In FIG. 1, the XFLM system 100 includes an sCMOS camera 101, a microlens array 103, a tube lens 105, a laser 107, a beam splitter 111, an objective lens 109, lenses 110 and 115, and one or more computers 135.

In FIG. 1, sCMOS camera 101 may capture a light-field video of a 3D volume of sample 120. Sample 120 may comprise an object that has a static (unchanging) portion and a dynamically changing portion. For instance, sample 120 may comprise neural tissue that fluoresces during neural activity.

In FIG. 1, laser 107 may emit light that stimulates fluorescence in sample 120. For instance, laser 107 may emit coherent blue light (e.g., with a wavelength of 473 nm) that excites fluorescence. The excitation illumination may travel from laser 107, through lens 110, then reflect from beam splitter 111, and then travel through objective lens 109 to sample 120.

In FIG. 1, in response to the excitation illumination, sample 120 emits fluorescent light. The fluorescent light may travel from sample 120, through objective lens 109, beam splitter 111, tube lens 105, convex lens 115, and microlens array 103, and then travel to an image sensor of sCMOS camera 101. The image sensor of sCMOS camera 101 may be located at the back focal plane of microlens array 103.

In FIG. 1, microlens array 103 is located at a conjugated rear focal plane 123 of the microscope. Put differently, in FIG. 1, microlens array 103 is located at a plane at which an image of the rear focal plane of the microscope is formed by light that has been relayed by relay lenses. Microlens array 103 may refract light in such a way as to enable the sCMOS camera to measure a light field. Put differently, microlens array 103 may refract light in such a way as to enable the sCMOS camera to measure angle-dependent intensity of light.

In FIG. 1, one or more computers 135: (a) control and interface with laser 107 and sCMOS camera 101; and (b) receive data from sCMOS camera 101. For instance, the one or more computers 135 may include a microcontroller and one or more personal computers. The one or more computers 135 may perform SDLFM computations. For instance, the one or more computers 135 may decompose a light-field video recording into additive non-negative components: a low rank non-negative component that corresponds to a static part of the recording and a sparse non-negative component that corresponds to the neuronal activity. The one or more computers 135 may then perform volume reconstruction (with regularization) on the sparse component, to calculate a light field video of a 3D volume of sample 120.

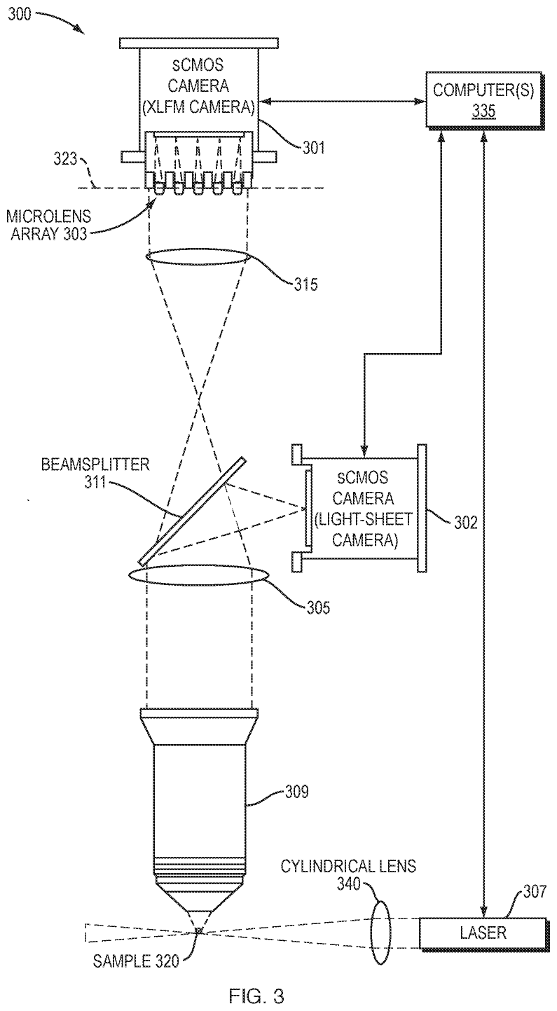

In FIGS. 1 and 3, each lens (e.g. 109, 309) may itself comprise a single lens, compound lens or a system of more than two lenses.

In FIGS. 1 and 3, an LFM camera (101, 301) measures both intensity and direction of incident light.

Decomposition into Low-Rank Matrix and Sparse Matrix

In illustrative implementations of this invention, a computer decomposes a light-field video recording into additive non-negative components: a low rank non-negative component that corresponds to the static part of the recording and a sparse non-negative component that corresponds to a dynamically changing part of the recording.

Specifically, in sparse decomposition light-field microscopy (SDLFM), a computer may decompose a raw light-field recording Y into two additive matrices by solving an optimization problem

$${min}_{L , S} {‖ L ‖}_{*} + λ {‖ S ‖}_{1} subject to Y = L + S , L \geq 0 , \\ S \geq 0 , \qquad ( Equation 1 )$$

where each column of Y is the light-field image at a different time point (i.e., Y=[y₁, . . . , y_{N}]), ∥L∥_{*} is the nuclear norm of L, and ∥S∥₁ is the L−1 norm of S, and λ is a constant scalar.

In Equation 1, low-rank matrix L and sparse matrix S are each a non-negative matrix: that is, each element of L and each element of S is greater than or equal to zero. In Equation 1, each column of Y may be a vector that encodes a frame of raw light field data. The number of elements in each column of Y may be equal to the number of pixels of the light field camera (and thus equal to the number of pixels in each frame of the raw light field data).

In illustrative implementations, the constant scalar λ is selected in such a way that background noise is barely captured in the sparse S matrix. For instance, in the context of fluorescent imaging of neural tissue, the constant λ in Equation 1 may be selected in such a way that a weak calcium signal is captured in S while maximizing the sparsity of S. In some cases, λ in Equation 1 is set at a constant value between 5×10⁻⁶ and 5×10⁻⁷. However, which constant value of λ is selected for Equation 1 depends on the data (e.g., type of sample being imaged). In some use scenarios in which light field images have a low SNR (signal-to-noise ratio), it is often desirable to employ a higher constant value of λ in Equation 1.

To solve the optimization problem in Equation 1, a computer may perform an alternating direction method of multipliers (ADMM), but with a modification to ensure non-negative components by enforcing non-negativity of L and S at the end of each iteration.

The modified ADMM algorithm may attempt to solve a problem

$${arg}_{x , z} min f ( x ) + g ( z ) subject to Ax + Bz = c \qquad ( Equation 2 )$$

where A, B, c, x and z are matrices or vectors.

To do so, the modified ADDM algorithm may perform the following iterations:

$${x}_{k + 1} = {arg}_{x} min {L}_{p} ( x , {z}_{k} , {y}_{k} ) \\ {x}_{k + 1} = max ( {x}_{k + 1} , 0 ) \\ {z}_{k + 1} = {arg}_{z} min {L}_{p} ( {x}_{k + 1} , z , {y}_{k} ) \\ {y}_{k + 1} = max ( {y}_{k + 1} , 0 ) \\ {y}_{k + 1} = {y}_{k + 1} + p ( A {x}_{k + 1} + B {z}_{k + 1} - c ) )$$

$$where$$

$${L}_{p} ( x , {z}_{k} , {y}_{k} ) = f ( x ) + g ( z ) + {y}^{T} ( A x + B z - c ) + ( \frac{p}{2} ) {\vert Ax + Bz - c \vert}_{2}^{2} ,$$

and where Lₚ, f and g are functions, the subscript k denotes the iteration index, p is a scalar value, and A, B, c, x, y and z are matrices or vectors.

In the iterations set forth in the preceding paragraph, the non-negativity of x and z is enforced by elementwise-projecting their values to a non-negative range after each update.

In some implementations of this invention, f(x)=∥x∥_{*}, g(z)=λ∥z∥₁, A=1, B=1, and c=Y, where ∥x∥_{*} is the nuclear norm of x, ∥z∥₁ is the L−1 norm of z; λ is a constant scalar, Y is a matrix that encodes the raw light field data, Lₚ, f and g are functions, and c, x and z are matrices.

Solving the optimization problem set forth in Equation 1 (by the modified ADDM method described above) may give a low rank matrix L which corresponds to a static (unchanging) part of the light-field images and a sparse matrix S which corresponds to a dynamically changing part of the light-field images. For instance, the dynamically changing part of the images may comprise fluorescence due to neuronal activity.

Alternatively, in some use scenarios in which there is almost no photo-bleaching (decrease of fluorescence signal over time), the non-negative low-rank component may be estimated by taking the pixel-wise minimum value.

### Volume Reconstruction

In illustrative implementations of this invention, after the light-field video recording of a sample is decomposed into a low-rank component and a sparse component, a computer may perform volume reconstruction (with regularization) on the sparse component, to calculate a light field video of a 3D volume of the sample.

Once the data is decomposed, volume reconstruction may be applied to each frame of the light-field recording (i.e., to each column of sparse matrix S, which we denote as yₛ) through the following Richardson-Lucy iterations:

$${x}_{k + 1} = ( P S {F}^{T} * \frac{{y}_{s}}{P S F * {x}_{k}} ) ⊙ {x}_{k}$$

where PSF is a matrix that encodes the point spread function of the optical system, PSF^{T} is the transpose of PSF, x is the volume to be reconstructed, subscript k denotes the iteration index, ⊙ denotes element-wise multiplication, * denotes matrix multiplication, and xₖ₊₁ and xₖ are vectors.

In some implementations, the volume reconstruction is performed with Richardson-Lucy iterations which include a regularization term that creates a weak preference for sparse solutions. Specifically, to add a sparsity constraint (regularization), the term

$$( \frac{1}{1 - {λ}_{D} {x}_{k}} )$$

may be included in each Richardson-Lucy iteration, as follows:

$${x}_{k + 1} = ( P S {F}^{T} * \frac{{y}_{s}}{P S F * {x}_{k}} ) ⊙ ( \frac{1}{1 - {λ}_{D} {x}_{k}} ) ⊙ {x}_{k}$$

where PSF is a matrix that encodes the point spread function of the optical system, PSF^{T} is the transpose of PSF, yₛ is a column of sparse matrix S, x is the volume to be reconstructed, subscript k denotes the iteration index, ⊙ denotes element-wise multiplication, λ_{D} is a parameter that determines the strength of the regularization, * denotes matrix multiplication, and xₖ₊₁ and xₖ are vectors.

In these iterations for volume reconstruction, A_{D} (the parameter that determines the strength of the regularization), is different from, and is unrelated to, which was involved in the sparse decomposition. In these iterations, multiplication by the term

$$( \frac{1}{1 - {λ}_{D} {x}_{k}} )$$

in each iteration may cause the algorithm to prefer a solution with a larger L2 norm. This preference may be equivalent to a smaller L0 norm (sparse), as the energy needs to be preserved (due to a constraint yₛ=PSF*x, where x is a vector).

This invention is not limited to Richardson-Lucy iteration (which is a multiplicative gradient-based update algorithm). In alternative implementations of this invention, other volume reconstruction methods may be used.

For instance, in some implementations, Landweber iteration (which is an which is an additive gradient-based update algorithm) may be employed for volume reconstruction.

In some cases, once the data is decomposed, volume reconstruction may be applied to each frame of the light-field recording (i.e., to each column of sparse matrix S, which we denote as yₛ) through the following Landweber iteration:

xₖ₊₁=xₖ−αPSF^{T}*(PSF*xₖ−yₛ)

where α is the relaxation factor that determines the update speed, where PSF is a matrix that encodes the point spread function of the optical system, PSF^{T} is the transpose of PSF, yₛ is a column of sparse matrix S, x is the volume to be reconstructed, subscript k denotes the iteration index, * denotes matrix multiplication, and xₖ₊₁ and xₖ are vectors.

In some cases, the volume reconstruction is performed with Landweber iterations which include a regularization term that creates a weak preference for sparse solutions. For instance, a sparsity constraint may be included in Landweber iteration, as follows:

xₖ₊₁=xₖ−αPSF^{T}*(PSF*xₖ−yₛ)

xₖ₊₁=max(xₖ₊₁−λ_{D},0)

where PSF is a matrix that encodes the point spread function of the optical system, PSF^{T} is the transpose of PSF, yₛ is a column of sparse matrix S, x is the volume to be reconstructed, subscript k denotes the iteration index, λ_{D} is a parameter that determines the strength of the regularization, * denotes matrix multiplication, and xₖ₊₁ and xₖ are vectors.

Again, λ_{D} (the parameter that determines the strength of the regularization), is different from, and is unrelated to, λ which was involved in the sparse decomposition.

In each of the iterations (which start with xₖ₊₁=, or with yₖ₊₁=, or with zₖ₊₁=) described in this section on Volume Reconstruction, = denotes an assignment operator.

In this section on Volume Reconstruction, each column of the sparse matrix S is denoted as yₛ and encodes a frame of the raw light-field video recording. Each frame of the raw light-field recording may be recorded at a different time interval of the recording.

Flowcharts

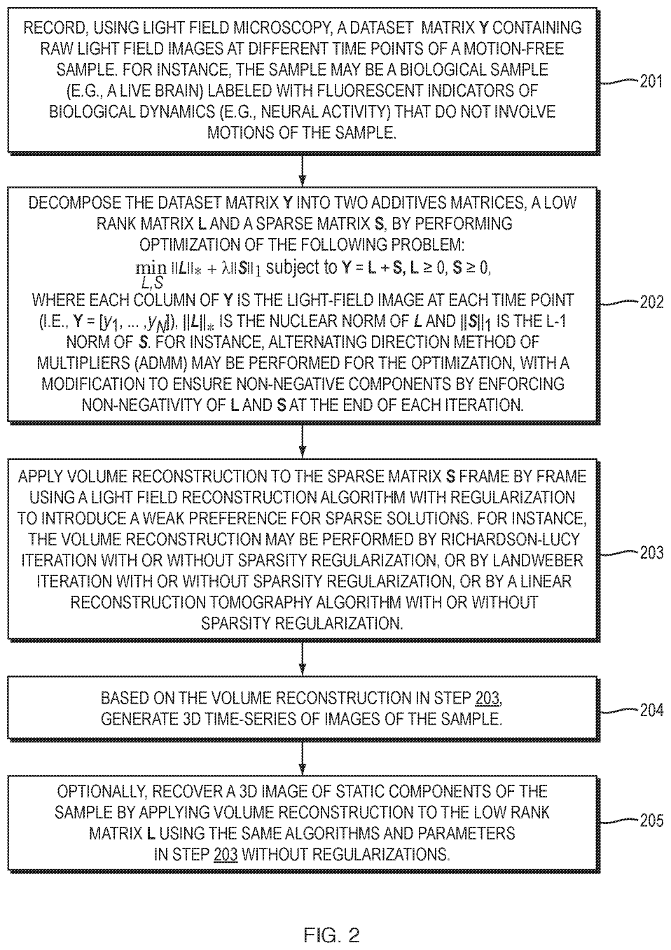

FIG. 2 is a flowchart for a method of sparse decomposition light field microscopy (SDLFM), in an illustrative implementation of this invention. The method shown in FIG. 2 includes at least the following steps: Record, using light field microscopy, a dataset matrix Y containing raw light field images at different time points of a motion-free sample. For instance, the sample may be a biological sample (e.g., a live brain) labeled with fluorescent indicators of biological dynamics (e.g., neural activity) that do not involve motions of the sample (Step 201). Decompose the dataset matrix Y into two additive matrices, a low rank matrix L and a sparse matrix S, by performing optimization of the following problem:

$${min}_{L , S} {‖ L ‖}_{*} + λ {‖ S ‖}_{1}$$

subject to Y=L+S, L≥0, S≥0, where each column of Y is the light-field image at each time point (i.e., Y=[y₁, . . . , y_{N}]), ∥L∥_{*} is the nuclear norm of L and ∥S∥₁ is the L−1 norm of S. For instance, alternating direction method of multipliers (ADMM) may be performed for the optimization, with a modification to ensure non-negative components by enforcing non-negativity of L and S at the end of each iteration (Step 202). Apply volume reconstruction to the sparse matrix S frame by frame using a light field reconstruction algorithm with regularization to introduce a weak preference for sparse solutions. For instance, the volume reconstruction may be performed by Richardson-Lucy iteration with or without sparsity regularization, or by Landweber iteration with or without sparsity regularization, or by a linear reconstruction tomography algorithm with or without sparsity regularization (Step 203). Based on the volume reconstruction in Step 203, generate 3D time-series of images of the sample (Step 204). Optionally, recover a 3D image of static components of the sample by applying volume reconstruction to the low rank matrix L using the same algorithms and parameters in Step 203 without regularizations (Step 205).

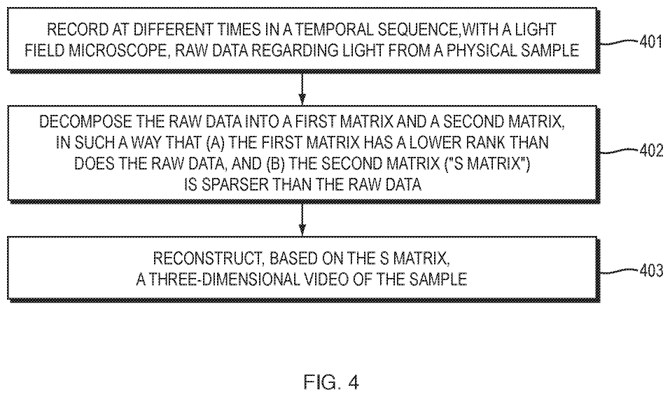

FIG. 4 is another flowchart of a method for sparse decomposition light field microscopy, in an illustrative implementation of this invention. The method shown in FIG. 4 includes at least the following steps: Record at different times in a temporal sequence, with a light field microscope, raw data regarding light from a physical sample (Step 401). Decompose the raw data into a first matrix and a second matrix, in such a way that (a) the first matrix has a lower rank than does the raw data, and (b) the second matrix (“S matrix”) is sparser than the raw data (Step 402) Reconstruct, based on the S matrix, a three-dimensional video of the sample (Step 403).

### Three Prototypes

The following eight paragraphs describe three prototypes of this invention.

The three prototypes employ, as microscopes, three different XLFMs (eXtended field of view LFMs). We sometimes refer to these three XLFMs as XLFM1, XLFM2, and XLFM3.

The first prototype (XLFM1) employs a 16×0.8NA water dipping objective lens for imaging, a blue laser (wavelength=473 nm) for excitation and a GFP (green fluorescent protein) filter set. A microlens array is mounted on the sCMOS camera using a continuous rotation lens mount, with the camera sensor at the back focal plane of the microlens array. The sCMOS camera is mounted on a 3-D translational platform for fine 3-D positioning to ensure the microlens array is accurately conjugated to the back focal plane of the objective lens through a 4f relay system (f1=180 mm, f2=125 mm).

The second prototype (XLFM2) is implemented by switching the microlens array of XLFM1. Specifically, microlenses with different focal lengths are used for XLFM2 in order to extend the axial field of view while maintaining the same magnification for each sub-image. This modification reduces the computational cost for the volume reconstruction by 50%.

The third prototype (XLFM3) has the same parts as XFLM1 and XFLM2, except that XLFM3 employs (a) a blue LED (light-emitting diode) as the light source; (b) a microlens array that supports a larger field of view; and (c) a different version of an sCMOS camera.

In these three prototypes (XLFM1, XLFM2, XLFM3), a computer workstation decomposes the raw light-field recording Y into two additive matrices L and S, by solving the optimization problem

$${min}_{L , S} {‖ L ‖}_{*} + λ {‖ S ‖}_{1}$$

subject to Y=L+S, L≥0, S≥0, where each column of Y is the light-field image at each time point (i.e., Y=[y₁, . . . , y_{N}]), ∥L∥_{*} is the nuclear norm of L and ∥S∥₁ is the L−1 norm of S. An alternating direction method of multipliers (ADMM) is employed for the optimization with a modification to ensure non-negative components by enforcing non-negativity of L and S at the end of each iteration. Solving this optimization problem gives a low rank matrix L which corresponds to a static part of the images and a sparse matrix S which corresponds to the neuronal activity. After the decomposition, volume reconstruction is applied to S rather than Y using Richardson-Lucy iterations with regularizations to introduce weak preference to sparse solutions. Both decomposition and volume reconstruction are performed partially on a workstation with a 16-core Intel® Xeon® processor, NVIDIA® Tesla™ K40c GPU (graphics processing unit) and 128 GB of RAM (random-access memory) and partially on a medium size cluster with multiple GPUs. The volume reconstruction of a single frame typically takes about 3 minutes on a single GPU with 30 iterations.

For these three prototypes, the empirical point spread function (PSF) of the microscopes was measured by imaging a 1-μm-diameter green fluorescent bead located at the center of the field of view with an axial step size of 2.5 μm for XLFM1 and XLFM2 and 4 μm for XLFM3. Typically, 200 images were taken for each PSF stack, which covered 500 μm, 500 μm and 800 μm axial fields of view for the three microscopes, respectively. After taking the stack, 10 background images were taken after shifting the bead sample laterally to move it away from the field of view. The averaged background image was subtracted from the measured raw PSF to remove the background component that comes from the ambient light, the camera offset and the reflection of excitation light. Due to the magnification ratio disparity of sub-images introduced by the axial displacement of the microlenses in XLFM1, the PSF was manually reorganized into two complementary parts for volume reconstruction.

In tests, these three prototypes achieve higher spatial resolution than conventional LFM methods without sacrificing temporal resolution. In some use scenarios, these three prototypes were applied to neuronal activity imaging of whole brains of larval zebrafish and adult Drosophila.

In this prototypes, the raw light-field recording is decomposed into a low rank component and a sparse component, thereby enabling the solution to the inverse problem to be recovered more accurately. In many use scenarios for these prototypes, it is desirable for the sample to be immobilized or head-fixed. However, in some cases, the eye movement of larval zebrafish is faithfully captured in the reconstructed volumes without artifacts, which indicates that decomposing into two components does not require the immobilization in a strict sense.

The prototypes described in the preceding eight paragraphs are non-limiting examples of this invention. This invention may be implemented in many different ways.

### Hybrid Optical System

In some implementations of this invention, a hybrid optical system simultaneously images a sample with both a light-sheet microscope (LSM) and an XFLM microscope. The video captured by the XFLM microscope may be decomposed into a non-negative low-rank component and a non-negative sparse component, and then volume reconstruction may be applied to the sparse component, as described above.

In this hybrid optical system, the sample may be illuminated with a light-sheet created by a cylindrical lens, while the sample is imaged by both the LSM microscope and the XFLM microscope (with decomposition of the XFLM video into a low-rank component and a sparse component, and volume reconstruction for the sparse component, as described above).

The following paragraph describes a prototype of this hybrid optical system.

In this prototype, a hybrid LSM-XLFM is built by adding light-sheet microscopy capability to XLFM2 (XLFM2 is described above). A stationary light-sheet is created at the focal plane of the detection objective lens by focusing an expanded laser beam using a cylindrical lens (f=75 mm). In the detection path, a beam splitter is inserted between the tube lens (f1=180 mm) and the image plane to evenly split the emission light. The light that is transmitted through the beam splitter forms XLFM images. The light that reflects from the beam splitter forms LSM images on an sCMOS camera. Digital triggers are generated using a PCIe® I/O card to synchronize the cameras.

The prototype described in the preceding paragraph is a non-limiting example of this invention. This invention may be implemented in many other ways.

FIG. 3 shows a hybrid LSM-XFLM system, in an illustrative implementation of this invention. In FIG. 3, the hybrid system 300 includes a first sCMOS camera 301 that captures XLFM images, a second sCMOS camera 302 that captures LSM images; a microlens array 303, a laser 307, a detection objective lens 309, lenses 305 and 315, a beam splitter 311, and one or more computers 335.

In FIG. 3, laser 107 may emit an expanded laser beam. Cylindrical lens 340 may focus the expanded laser beam into a stationary light-sheet at the focal plane of detection objective lens 309. The light emitted by laser 307 may excite fluorescence in sample 320.

In FIG. 3, in response to the excitation illumination, sample 320 emits fluorescent light. Light (including fluorescent light and reflected light) may travel from sample 320, through detection objective lens 309, lens 305, and then to beam splitter 311. A portion of the light may pass through beam splitter 311, then through lens 315, then through microlens array 303, and then travel to an image sensor of a first sCMOS camera 301 that performs XFLM imaging. Another portion of the light may reflect from beam splitter 311 to camera 302 which performs LSM imaging.

In FIG. 3, microlens array 303 is located at a conjugated rear focal plane 323 of the microscope. In other words, in FIG. 3, microlens array 303 is located at a plane at which an image of the rear focal plane of the microscope is formed by light that has been relayed by relay lenses. Microlens array 303 may refract light in such a way as to enable camera 301 to measure a light field. Put differently, microlens array 303 may refract light in such a way as to enable camera 301 to measure angle-dependent intensity of light. The image sensor of camera 301 may be located at the back focal plane of microlens array 303.

In FIG. 3, one or more computers 335: (a) control and interface with laser 307 and cameras 301 and 302; and (b) receive data from cameras 301 and 302. For instance, the one or more computers 335 may include a microcontroller and one or more personal computers. The one or more computers 335 may decompose a light-field video recording (captured by camera 301) into additive non-negative components: a low rank non-negative component that corresponds to a static part of the recording and a sparse non-negative component that corresponds a dynamically changing part of the recording (e.g., changing fluorescence due to neuronal activity). The one or more computers 335 may then perform volume reconstruction (with regularization) for the sparse component, to calculate a light field video of a 3D volume of sample 320. In addition, the one or more computers 335 may process data captured by camera 302 to create LSM images.

### Applications

As noted above, in illustrative implementations of this invention, an imaging system performs what we sometimes call “sparse decomposition light-field microscopy” or “SDLFM”. In SDLFM, raw light-field video data may be captured by a light-field microscope and then may be decomposed into a non-negative low-rank component and a non-negative sparse component, and then volume reconstruction may be performed on the sparse component.

In some implementations of this invention, an imaging system performs SDLFM to image a fluorescent sample. For instance, an imaging system may perform SDLFM to image neural activity with fluorescent markers.

In some cases, SDLFM is employed to create a light-field video of a sample that has both: (a) a static part that does not move and that has a steady brightness, and (b) a dynamically changing part. For example, the dynamically changing part may be local spikes in fluorescence.

In some use scenarios, an imaging system performs SDLFM to image blood flow within an immobilized biological specimen. In these use scenarios, blood flow may correspond to the S (sparse) matrix and everything else in the image (e.g., background fluorescence, auto-fluorescence, and fluorescence signal from everything else) may correspond to the L (low-rank) matrix.

In other used scenarios, an imaging system performs SDLFM to image cell migrations in 3D. For instance, if a cell type of interest has a fluorescent signal and there are other sources of fluorescence within the field-of-view, SDLFM can be used to monitor the migration of the cells of interest with higher resolution.

### Software

In the Computer Program Listing above, eleven computer program files are listed. These eleven computer program files comprise software employed in a prototype of this invention.

In order to submit these eleven programs to the U.S. Patent and Trademark Office, the eleven program files were converted to ASCII .txt format. In each of these eleven programs, these changes may be reversed, so that the eleven programs may be run as MATLAB® programs. Specifically, these changes may be reversed by changing the filename extension for each program from “.txt” to “.m”.

This invention is not limited to the software set forth in these eleven computer program files. Other software may be employed. Depending on the particular implementation, the software used in this invention may vary.

### Computers

In illustrative implementations of this invention, one or more computers (e.g., servers, network hosts, client computers, integrated circuits, microcontrollers, controllers, microprocessors, field-programmable-gate arrays, personal computers, digital computers, driver circuits, or analog computers) are programmed or specially adapted to perform one or more of the following tasks: (1) to control the operation of, or interface with, hardware components of an LFM imaging system, including any camera, laser or light-emitting diode; (2) to decompose LFM data into a non-negative low-rank component and a non-negative sparse component; (3) to perform volume reconstruction on the sparse component (e.g., with Richardson-Lucy iterations or Landweber iterations); (4) to perform volume reconstruction on the low-rank component; (5) to receive data from, control, or interface with one or more sensors; (6) to perform any other calculation, computation, program, algorithm, or computer function described or implied herein; (7) to receive signals indicative of human input; (8) to output signals for controlling transducers for outputting information in human perceivable format; (9) to process data, to perform computations, and to execute any algorithm or software; and (10) to control the read or write of data to and from memory devices (tasks 1-10 of this sentence being referred to herein as the “Computer Tasks”). The one or more computers (e.g. 135, 335) may, in some cases, communicate with each other or with other devices: (a) wirelessly, (b) by wired connection, (c) by fiber-optic link, or (d) by a combination of wired, wireless or fiber optic links.

In exemplary implementations, one or more computers are programmed to perform any and all calculations, computations, programs, algorithms, computer functions and computer tasks described or implied herein. For example, in some cases: (a) a machine-accessible medium has instructions encoded thereon that specify steps in a software program; and (b) the computer accesses the instructions encoded on the machine-accessible medium, in order to determine steps to execute in the program. In exemplary implementations, the machine-accessible medium may comprise a tangible non-transitory medium. In some cases, the machine-accessible medium comprises (a) a memory unit or (b) an auxiliary memory storage device. For example, in some cases, a control unit in a computer fetches the instructions from memory.

In illustrative implementations, one or more computers execute programs according to instructions encoded in one or more tangible, non-transitory, computer-readable media. For example, in some cases, these instructions comprise instructions for a computer to perform any calculation, computation, program, algorithm, or computer function described or implied herein. For instance, in some cases, instructions encoded in a tangible, non-transitory, computer-accessible medium comprise instructions for a computer to perform the Computer Tasks.

### Computer Readable Media

In some implementations, this invention comprises one or more computers that are programmed to perform one or more of the Computer Tasks.

In some implementations, this invention comprises one or more tangible, non-transitory, machine readable media, with instructions encoded thereon for one or more computers to perform one or more of the Computer Tasks.

In some implementations, this invention comprises participating in a download of software, where the software comprises instructions for one or more computers to perform one or more of the Computer Tasks. For instance, the participating may comprise (a) a computer providing the software during the download, or (b) a computer receiving the software during the download.

### Network Communication

In illustrative implementations of this invention, one or more devices (e.g., 101, 107, 135, 301, 302, 307, 335) are configured for wireless or wired communication with other devices in a network.

For example, in some cases, one or more of these devices include a wireless module for wireless communication with other devices in a network. Each wireless module may include (a) one or more antennas, (b) one or more wireless transceivers, transmitters or receivers, and (c) signal processing circuitry. Each wireless module may receive and transmit data in accordance with one or more wireless standards.

In some cases, one or more of the following hardware components are used for network communication: a computer bus, a computer port, network connection, network interface device, host adapter, wireless module, wireless card, signal processor, modem, router, cables and wiring.

In some cases, one or more computers (e.g. 135, 335)) are programmed for communication over a network. For example, in some cases, one or more computers are programmed for network communication: (a) in accordance with the Internet Protocol Suite, or (b) in accordance with any other industry standard for communication, including any USB standard, ethernet standard (e.g., IEEE 802.3), token ring standard (e.g., IEEE 802.5), or wireless communication standard, including IEEE 802.11 (Wi-Fi®), IEEE 802.15 (Bluetooth®/Zigbee®), IEEE 802.16, IEEE 802.20, GSM (global system for mobile communications), UMTS (universal mobile telecommunication system), CDMA (code division multiple access, including IS-95, IS-2000, and WCDMA), LTE (long term evolution), or 5G (e.g., ITU IMT-2020).

### Definitions

The terms “a” and “an”, when modifying a noun, do not imply that only one of the noun exists. For example, a statement that “an apple is hanging from a branch”: (i) does not imply that only one apple is hanging from the branch; (ii) is true if one apple is hanging from the branch; and (iii) is true if multiple apples are hanging from the branch.

To say that a calculation is “according to” a first equation means that the calculation includes (a) solving the first equation; or (b) solving a second equation, where the second equation is derived from the first equation. Non-limiting examples of “solving” an equation include solving the equation in closed form or by numerical approximation or by optimization.

To compute “based on” specified data means to perform a computation that takes the specified data as an input.

The term “comprise” (and grammatical variations thereof) shall be construed as if followed by “without limitation”. If A comprises B, then A includes B and may include other things.

A digital computer is a non-limiting example of a “computer”. An analog computer is a non-limiting example of a “computer”. A computer that performs both analog and digital computations is a non-limiting example of a “computer”. However, a human is not a “computer”, as that term is used herein.

“Computer Tasks” is defined above.

“Defined Term” means a term or phrase that is set forth in quotation marks in this Definitions section.

For an event to occur “during” a time period, it is not necessary that the event occur throughout the entire time period. For example, an event that occurs during only a portion of a given time period occurs “during” the given time period.

The term “e.g.” means for example.

Each equation above may be referred to herein by the equation number set forth to the right of the equation. Non-limiting examples of an “equation”, as that term is used herein, include: (a) an equation that states an equality; (b) an inequation that states an inequality; (c) a mathematical statement of proportionality or inverse proportionality; (d) a system of equations; (e) a mathematical optimization problem; or (f) a mathematical expression.

The fact that an “example” or multiple examples of something are given does not imply that they are the only instances of that thing. An example (or a group of examples) is merely a non-exhaustive and non-limiting illustration.

Unless the context clearly indicates otherwise: (1) a phrase that includes “a first” thing and “a second” thing does not imply an order of the two things (or that there are only two of the things); and (2) such a phrase is simply a way of identifying the two things, so that they each may be referred to later with specificity (e.g., by referring to “the first” thing and “the second” thing later). For example, if a device has a first socket and a second socket, then, unless the context clearly indicates otherwise, the device may have two or more sockets, and the first socket may occur in any spatial order relative to the second socket. A phrase that includes a “third” thing, a “fourth” thing and so on shall be construed in like manner.

“For instance” means for example.

To say a “given” X is simply a way of identifying the X, such that the X may be referred to later with specificity. To say a “given” X does not create any implication regarding X. For example, to say a “given” X does not create any implication that X is a gift, assumption, or known fact.

“Herein” means in this document, including text, specification, claims, abstract, and drawings.

As used herein: (1) “implementation” means an implementation of this invention; (2) “embodiment” means an embodiment of this invention; (3) “case” means an implementation of this invention; and (4) “use scenario” means a use scenario of this invention.

The term “include” (and grammatical variations thereof) shall be construed as if followed by “without limitation”.

“Intensity” means any radiometric or photometric measure of intensity, energy or power. Each of the following is a non-limiting example of “intensity” of light: irradiance, spectral irradiance, radiant energy, radiant flux, spectral power, radiant intensity, spectral intensity, radiance, spectral radiance, radiant exitance, radiant emittance, spectral radiant exitance, spectral radiant emittance, radiosity, radiant exposure, radiant energy density, luminance, luminous intensity, luminous energy, luminous flux, luminous power, illuminance, luminous exitance, luminous emittance, luminous exposure, and luminous energy density.

“Light” means electromagnetic radiation of any frequency. For example, “light” includes, among other things, visible light and infrared light. Likewise, any term that directly or indirectly relates to light (e.g., “imaging”) shall be construed broadly as applying to electromagnetic radiation of any frequency.

As used herein, a single scalar is not a “matrix”.

To “multiply” includes to multiply by an inverse. Thus, to “multiply” includes to divide.

Unless the context clearly indicates otherwise, “or” means and/or. For example, A or B is true if A is true, or B is true, or both A and B are true. Also, for example, a calculation of A or B means a calculation of A, or a calculation of B, or a calculation of A and B.

As used herein, the term “set” does not include a group with no elements.

Unless the context clearly indicates otherwise, “some” means one or more.

As used herein, a “subset” of a set consists of less than all of the elements of the set.

The term “such as” means for example.

To say that a machine-readable medium is “transitory” means that the medium is a transitory signal, such as an electromagnetic wave.

Except to the extent that the context clearly requires otherwise, if steps in a method are described herein, then the method includes variations in which: (1) steps in the method occur in any order or sequence, including any order or sequence different than that described herein; (2) any step or steps in the method occur more than once; (3) any two steps occur the same number of times or a different number of times during the method; (4) one or more steps in the method are done in parallel or serially; (5) any step in the method is performed iteratively; (6) a given step in the method is applied to the same thing each time that the given step occurs or is applied to a different thing each time that the given step occurs; (7) one or more steps occur simultaneously; or (8) the method includes other steps, in addition to the steps described herein.

Headings are included herein merely to facilitate a reader's navigation of this document. A heading for a section does not affect the meaning or scope of that section.

This Definitions section shall, in all cases, control over and override any other definition of the Defined Terms. The Applicant or Applicants are acting as his, her, its or their own lexicographer with respect to the Defined Terms. For example, the definitions of Defined Terms set forth in this Definitions section override common usage and any external dictionary. If a given term is explicitly or implicitly defined in this document, then that definition shall be controlling, and shall override any definition of the given term arising from any source (e.g., a dictionary or common usage) that is external to this document. If this document provides clarification regarding the meaning of a particular term, then that clarification shall, to the extent applicable, override any definition of the given term arising from any source (e.g., a dictionary or common usage) that is external to this document. Unless the context clearly indicates otherwise, any definition or clarification herein of a term or phrase applies to any grammatical variation of the term or phrase, taking into account the difference in grammatical form. For example, the grammatical variations include noun, verb, participle, adjective, and possessive forms, and different declensions, and different tenses.

### Variations

This invention may be implemented in many different ways. Here are some non-limiting examples:

In some implementations, this invention is a method comprising: (a) recording at different times in a temporal sequence, with a light field microscope, data regarding light from a physical sample; (b) decomposing the data into a first matrix and a second matrix, in such a way that (i) the first matrix (“L matrix”) has a lower rank than does the data, and (ii) the second matrix (“S matrix”) is sparser than the data; and (c) reconstructing, based on the S matrix, a three-dimensional video of the sample. In some cases, the L0 norm of the S matrix is less than the L0 norm of the data. In some cases: (a) each element of the L matrix is greater than or equal to zero; and (b) each element of the S matrix is greater than or equal to zero. In some cases, the decomposing, into the L matrix and the S matrix, includes performing Robust Principal Component analysis. In some cases, the reconstructing, based on the S matrix, includes performing Richardson-Lucy iterations. In some cases, the reconstructing, based on the S matrix, includes performing a multiplicative gradient-based update algorithm. In some cases, the reconstructing, based on the S matrix, includes performing Landweber iterations. In some cases, the reconstructing, based on the S matrix, includes performing an additive gradient-based update algorithm. In some cases, the data encodes angle-dependent intensity of the light from the sample. In some cases, the light from the sample includes fluorescent light emitted by the sample. In some cases, the light from the sample includes fluorescent light that: (a) is emitted by the sample; and (b) is indicative of neural activity in the sample. In some cases: (a) the method includes illuminating the sample with a lightsheet; and (b) the light from the sample includes fluorescent light emitted by the sample. In some cases, throughout the recording, the sample does not move relative to the light field microscope. Each of the cases described above in this paragraph is an example of the method described in the first sentence of this paragraph, and is also an example of an embodiment of this invention that may be combined with other embodiments of this invention.

In some implementations, this invention is an apparatus comprising: (a) a light field microscope; and (b) one or more computers; wherein (i) the light field microscope is configured to record, at different times in a temporal sequence, data regarding light from a physical sample, and (ii) the one or more computers are programmed (A) to perform calculations (“decomposition calculations”) that decompose the data into a first matrix and a second matrix, in such a way that (I) the first matrix (“L matrix”) has a lower rank than does the data, and (II) the second matrix (“S matrix”) is sparser than the data, and (B) to perform other calculations (“reconstruction calculations”) that reconstruct, based on the S matrix, a three-dimensional video of the sample. In some cases, the apparatus further comprises a light source that is configured to excite fluorescence in the sample. In some cases: (a) the apparatus further comprises a laser and a cylindrical lens; and (b) the apparatus is configured in such a way that light from the laser is refracted by the cylindrical lens to form a light sheet that illuminates the sample. In some cases, the L0 norm of the S matrix is less than the L0 norm of the data. In some cases: (a) each element of the L matrix is greater than or equal to zero; and (b) each element of the S matrix is greater than or equal to zero. In some cases, the decomposition calculations: (a) take the data recorded by the light field microscope as an input; and (b) include Alternating Direction Method of Multipliers computations. In some cases, the reconstruction calculations: (a) take the data recorded by the light field microscope as an input; and (b) include Richardson-Lucy iterations. Each of the cases described above in this paragraph is an example of the apparatus described in the first sentence of this paragraph, and is also an example of an embodiment of this invention that may be combined with other embodiments of this invention.

Each description herein (or in the Provisional) of any method, apparatus or system of this invention describes a non-limiting example of this invention. This invention is not limited to those examples, and may be implemented in other ways.

Each description herein (or in the Provisional) of any prototype of this invention describes a non-limiting example of this invention. This invention is not limited to those examples, and may be implemented in other ways.

Each description herein (or in the Provisional) of any implementation, embodiment or case of this invention (or any use scenario for this invention) describes a non-limiting example of this invention. This invention is not limited to those examples, and may be implemented in other ways.

Each Figure, diagram, schematic or drawing herein (or in the Provisional) that illustrates any feature of this invention shows a non-limiting example of this invention. This invention is not limited to those examples, and may be implemented in other ways.

The above description (including without limitation any attached drawings and figures) describes illustrative implementations of the invention. However, the invention may be implemented in other ways. The methods and apparatus which are described herein are merely illustrative applications of the principles of the invention. Other arrangements, methods, modifications, and substitutions by one of ordinary skill in the art are also within the scope of the present invention. Numerous modifications may be made by those skilled in the art without departing from the scope of the invention. Also, this invention includes without limitation each combination and permutation of one or more of the items (including any hardware, hardware components, methods, processes, steps, software, algorithms, features, and technology) that are described herein.

What is claimed:

1. A method comprising:
(a) recording at different times in a temporal sequence, with a light field microscope, data regarding light from a physical sample;
(b) decomposing the data into a first matrix and a second matrix, in such a way that
(i) the first matrix (“L matrix”) has a lower rank than does the data, and
(ii) the second matrix (“S matrix”) is sparser than the data; and
(c) reconstructing, based on the S matrix, a three-dimensional video of the sample.

2. The method of claim 1, wherein the L0 norm of the S matrix is less than the L0 norm of the data.

3. The method of claim 1, wherein:
(a) each element of the L matrix is greater than or equal to zero; and
(b) each element of the S matrix is greater than or equal to zero.

4. The method of claim 1, wherein the decomposing, into the L matrix and the S matrix, includes performing Robust Principal Component analysis.

5. The method of claim 1, wherein the reconstructing, based on the S matrix, includes performing Richardson-Lucy iterations.

6. The method of claim 1, wherein the reconstructing, based on the S matrix, includes performing a multiplicative gradient-based update algorithm.

7. The method of claim 1, wherein the reconstructing, based on the S matrix, includes performing Landweber iterations.

8. The method of claim 1, wherein the reconstructing, based on the S matrix, includes performing an additive gradient-based update algorithm.

9. The method of claim 1, wherein the data encodes angle-dependent intensity of the light from the sample.

10. The method of claim 1, wherein the light from the sample includes fluorescent light emitted by the sample.

11. The method of claim 1, wherein the light from the sample includes fluorescent light that:
(a) is emitted by the sample; and
(b) is indicative of neural activity in the sample.

12. The method of claim 1, wherein:
(a) the method includes illuminating the sample with a lightsheet; and
(b) the light from the sample includes fluorescent light emitted by the sample.

13. The method of claim 1, wherein, throughout the recording, the sample does not move relative to the light field microscope.

14. An apparatus comprising:
(a) a light field microscope; and
(b) one or more computers;
wherein
(i) the light field microscope is configured to record, at different times in a temporal sequence, data regarding light from a physical sample, and
(ii) the one or more computers are programmed
(A) to perform calculations (“decomposition calculations”) that decompose the data into a first matrix and a second matrix, in such a way that (I) the first matrix (“L matrix”) has a lower rank than does the data, and (II) the second matrix (“S matrix”) is sparser than the data, and
(B) to perform other calculations (“reconstruction calculations”) that reconstruct, based on the S matrix, a three-dimensional video of the sample.

15. The apparatus of claim 14, wherein the apparatus further comprises a light source that is configured to excite fluorescence in the sample.

16. The apparatus of claim 14, wherein:
(a) the apparatus further comprises a laser and a cylindrical lens; and
(b) the apparatus is configured in such a way that light from the laser is refracted by the cylindrical lens to form a light sheet that illuminates the sample.

17. The apparatus of claim 14, wherein the L0 norm of the S matrix is less than the L0 norm of the data.

18. The apparatus of claim 14, wherein:
(a) each element of the L matrix is greater than or equal to zero; and
(b) each element of the S matrix is greater than or equal to zero.

19. The apparatus of claim 14, wherein the decomposition calculations:
(a) take the data recorded by the light field microscope as an input; and
(b) include Alternating Direction Method of Multipliers computations.

20. The apparatus of claim 14, wherein the reconstruction calculations:
(a) take the data recorded by the light field microscope as an input; and
(b) include Richardson-Lucy iterations.
